(19) United States
(12) Patent Application Publication
(10) Pub. No.: US 2005/0183747 A1
(43) Pub. Date: Aug. 25, 2005

(54) Method for reducing contact angle of water on TAC film

(75) Inventors: Yi-Ping Wang, Ping Chen City (TW); Yao-Chung Cheng, Ping Chen City (TW); Ming-Chih Shih, Ping Chen City (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: OPTIMAX TECHNOLOGY CORPORATION, Ping Chen City (TW)

(21) Appl. No.: 10/949,188

(22) Filed: Sep. 27, 2004

(30) Foreign Application Priority Data
Feb. 20, 2004 (TW) 93104361

(51) Int. Cl. G03C 1/735; B08B 3/00

(52) U.S. Cl. 134/26

(57) ABSTRACT

A TAC film pre-processing method for reducing the contact angle of water on the TAC film is described. In this method, the TAC film is first passed through a base tank to perform a base cleaning process. Next, the TAC film is passed through a first rinse tank to perform a first water cleaning process. The TAC film is then passed through an acid tank to perform an acid cleaning process. Finally, the TAC film is passed through a second rinse tank to performing a second water cleaning process. Alcohol is added at a predetermined concentration to the second rinse tank. The alcohol includes IPA (isopropyl alcohol). The predetermined concentration range of the alcohol is from about 4% to 6%.

### RELATED APPLICATION

The present application is based on, and claims priority from, Taiwan Application Serial number 93104361, filed Feb. 20, 2004, the disclosure of which is hereby incorporated by reference herein in its entirety.

### BACKGROUND

1. Field of Invention

The present invention relates to a TAC film pre-processing method. More particularly, the present invention relates to a TAC film pre-processing method for reducing the contact angle of water on a TAC film.

2. Description of Related Art

LCD displays are one of the most rapidly developed display technologies in the world. In the field of computer industry, computers having LCD displays occupy a very large market share, Moreover, in the market of home televisions, the ratio of televisions with LCD displays (LCDTV) is growing rapidly. Therefore, LCD displays will play a very important role in the future.

An LCD display includes, for example, a back light module, polarizers, a liquid crystal layer and color filters. A polarizer allows a light that is linearly polarized in a specific direction to pass. When the LCD display is controlled by an external voltage, the LCD display is capable of generating a white mode and a black mode. Thus, the LCD display can be controlled to show images.

Therefore, a polarizer plays an important role in an LCD display. Generally speaking, the structure of a polarizer is made by sandwiching a PVA (poly vinyl alcohol) film between two TAC (cellulose tri-acetate) films. The interface between the PVA film and the TAC film is a hydrophilic interface, so that a more hydrophilic TAC film attaches to the PVA film more easily. Therefore, before the TAC film is attached to the PVA film, the TAC film is be pre-processed to obtain a smaller contact angle of water, i.e. a better hydrophilic character.

### SUMMARY

It is therefore an objective of the present invention to provide a TAC film pre-processing method that is capable of reducing the contact angle of water on a TAC film.

It is another objective of the present invention to provide a TAC film pre-processing method for reducing the contact angle of water on a TAC film, which method is simple, fast, and greatly reduces the contact angle.

It is still another objective of the present invention to provide a TAC film pre-processing method for reducing the contact angle of water on a TAC film, which method is cheap.

In accordance with the foregoing and other objectives of the present invention, a TAC film pre-processing method for reducing the contact angle of water on a TAC film is provided. The method includes the following steps.

First, a base cleaning process is performed by passing the TAC film through a base tank. Then, a first water cleaning process is performed by passing the TAC film through a first rinse tank. Following that, an acid cleaning process is performed by passing the TAC film through an acid tank. Then, a second water cleaning process is performed by passing the TAC film through a second rinse tank, in which an alcohol is added to the second rinse tank at a predetermined concentration. The base cleaning process, the first water cleaning process, and the acid cleaning process as a whole is called a chemical cleaning process. The alcohol can be methanol, ethanol, or propanol, and is preferably iso-propanol (IPA). In the second rinse tank, the predetermined concentration of the alcohol is from 2% to 100%, and preferably from 4% to 6%.

The invention has at least the following advantages. The TAC film pre-processing method can effectively reduce the contact angle of water on the TAC film. The method is simple, fast and cheap, and is achieved by adding an alcohol to the second rinse tank.

It is to be understood that both the foregoing general description and the following detailed description are examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram illustrating the structure of a polarizer;

FIG. 2 is a diagram illustrating a contact angle of water on a TAC film; and

FIG. 3 is a flow chart illustrating an exemplary TAC film pre-processing method.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

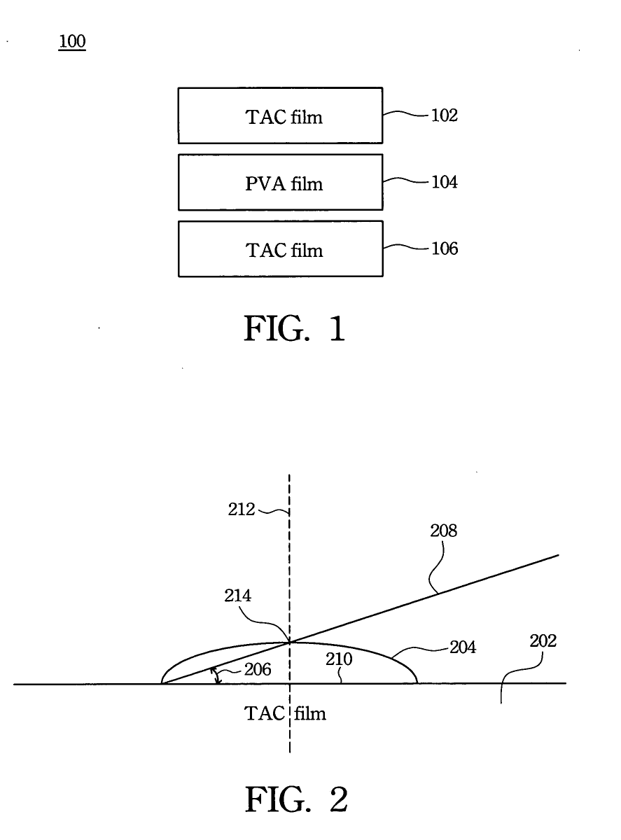

FIG. 1 is a diagram illustrating the structure of a polarizer. With reference to FIG. 1, the polarizer 100 includes a TAC film 102, a PVA film 104, and another TAC film 106. The TAC film 102 and 106 are composed of cellulose tri-acetate. The PVA film 104 is composed of poly vinyl alcohol. The polarizer 100 is used in an LCD display.

Before the TAC film 102, the PVA film 104, and the TAC film 106 are attached together, the TAC film 102 and the TAC film 106 have to be pre-processed, so that the contact angle of water on the TAC film 102 or the TAC film 106 is smaller than 20 degrees. Because the interface between the PVA film 104 and the TAC film 106 is a hydrophilic interface, the contact angle of water on the TAC film 102 or the TAC film 106 should be smaller than 20 degrees for tight cohesion.

FIG. 2 is a diagram illustrating a contact angle of water on a TAC film. A water drop 204 is on the TAC film 202. The contact angle of water on TAC film 202 is defined as twice the angle 206. The angle 206 is between the line 208 and the interface 210. The line 212 is perpendicular to the interface 210 and divides the water drop 204 into two equal parts. Line 212 and line 208 intersect at the point 214 on the surface of the water drop 204.

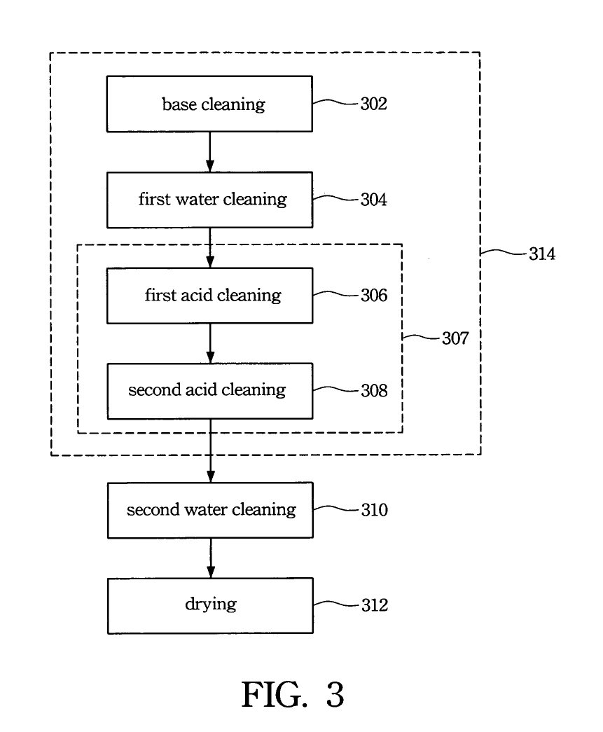

FIG. 3 is a flow chart illustrating an exemplary TAC film pre-processing method. With reference to FIG. 3, the TAC film pre-processing method includes a chemical cleaning process (step 314), a second water cleaning process (step 310) and a drying process (step 312). The chemical cleaning process (step 314) includes, for example, a base cleaning process (step 302), a first water cleaning process (step 304), a first acid cleaning process (step 306), and a second acid cleaning process (step 308). Details of these processes are described as follows. First, a base cleaning process is performed by passing the TAC film through a base tank (step 302). The base tank contains KOH and the concentration of KOH is about 1.6 N. The temperature is about 50 degrees Celsius. The process time of the base cleaning is about 100 seconds. Then, a first water cleaning process is performed by passing the TAC film through a first rinse tank (step 304). The temperature is about 25 degrees Celsius. The process time of the first water cleaning process is about 4 seconds. Next, a first acid cleaning process is performed by passing the TAC film through a first acid tank (step 306).

Following that, a second acid cleaning process is performed by passing the TAC film through a second acid tank (step 308). The first acid cleaning process combined with the second acid cleaning process is called an acid cleaning process (step 307). The first acid tank and the second acid tank both contain, for example, H₂SO₄. The concentration of H₂SO₄ is about 0.1 N in both the first acid tank and the second acid tank. The total acid cleaning process time is about 4 seconds and the temperature is about 25 degrees Celsius.

Then, a second water cleaning process is performed by passing the TAC film through a second rinse tank (step 310). An alcohol is added at a predetermined concentration to the second rinse tank. For example, the alcohol can be methanol, ethanol, or propanol. A preferred alcohol is isopropanol. For example, in the second rinse tank, the predetermined concentration of the alcohol is from 2% to 100%, and preferably from 4% to 6%.

Subsequently, a drying process (step 312) is performed by putting the TAC film into an oven. The temperature is about 100 degrees Celsius and the drying process time is about 10 minutes. Then, a pre-processing process is completed. In an experimental test, the contact angle of water on the TAC film is 17.2 degrees before adding an alcohol to the second rinse tank and 13.2 degrees after adding the alcohol to the second rinse tank. The contact angle is far smaller than the 20-degree requirement. Therefore, the method mentioned above can effectively reduce the contact angle of water on the TAC film.

Although the present invention has been described in considerable detail with reference to certain preferred embodiments thereof, other embodiments are possible. Therefore, their spirit and scope of the appended claims should not be limited to the description of the preferred embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A TAC film pre-processing method for reducing the contact angle of water on a TAC film, the method comprising:
performing a base cleaning process by passing the TAC film through a ase tank;
performing a first water cleaning process by passing the TAC film through a first rinse tank;
performing an acid cleaning process by passing the TAC film through an acid tank; and
performing a second water cleaning process by passing the TAC film through a second rinse tank, wherein alcohol is added at a predetermined concentration to the second rinse tank.

2. The TAC film pre-processing method of claim 1, wherein the alcohol is selected from the group consisting of methanol, ethanol, and propanol.

3. The TAC film pre-processing method of claim 1, wherein the alcohol is isopropanol.

4. The TAC film pre-processing method of claim 1, wherein the predetermined concentration of the alcohol is from about 2% to 100%.

5. The TAC film pre-processing method of claim 4, wherein the predetermined concentration of the alcohol is from about 4% to 6%.

6. A method for reducing the contact angle of water on a TAC film, the method being used in a TAC film pre-processing process, the method comprising:
adding an alcohol at a predetermined concentration to a rinse tank; and
performing a water cleaning process by passing the TAC film through the rinse tank, wherein the water cleaning process is a last water cleaning process in the TAC film pre-processing process.

7. The method of claim 6, wherein the alcohol is selected from the group consisting of methanol, ethanol, and propanol.

8. The method of claim 6, wherein the alcohol is iso-propanol.

9. The method of claim 6, wherein the predetermined concentration of the alcohol is from about 2% to 100%.

10. The method of claim 9, wherein the predetermined concentration of the alcohol is from about 4% to 6%.

11. A TAC film pre-processing method for reducing the contact angle of water on a TAC film, the method comprising:
performing a chemical cleaning process on the TAC film; and
performing a water cleaning process by passing the TAC film through a rinse tank, wherein an alcohol is added at a predetermined concentration to the rinse tank.

12. The TAC film pre-processing method of claim 11, wherein the alcohol is selected from the group consisting of methanol, ethanol, and propanol.

13. The TAC film pre-processing method of claim 11, wherein the alcohol is isopropanol.

14. The TAC film pre-processing method of claim 11, wherein the predetermined concentration of the alcohol is from about 2% to 100%.

15. The TAC film pre-processing method of claim 14, wherein the predetermined concentration of the alcohol is from about 4% to 6%.

16. The TAC film pre-processing method of claim 11, wherein the chemical cleaning process comprises a base cleaning process, a water cleaning process, and an acid cleaning process.

17. A method for reducing the contact angle of water on a TAC film, the method being used in a TAC film pre-processing process, the TAC film being processed by a chemical cleaning process in advance, the method comprising:
adding an alcohol at a predetermined concentration to a rinse tank; and
performing a water cleaning process by passing the TAC film through the rinse tank.

18. The method of claim 17, wherein the alcohol is selected from a group consisting of methanol, ethanol, and propanol.

19. The method of claim 17, wherein the alcohol is iso-propanol.

20. The method of claim 17, wherein the predetermined concentration of the alcohol is from about 2% to 100%.

21. The method of claim 20, wherein the predetermined concentration of the alcohol is from about 4% to 6%.

22. The method of claim 17, wherein the chemical cleaning process comprises a base cleaning process, a water cleaning process, and an acid cleaning process.
